(19) United States
(12) Patent Application Publication
(10) Pub. No.: US 2020/0332138 A1
(43) Pub. Date: Oct. 22, 2020

(54) Ink Jet Printing Ink Composition And Ink Jet Printing Method

(71) Applicant: Seiko Epson Corporation, Tokyo (JP)

(72) Inventors: Minoru YAMADA, Shiojiri (JP); Masakazu OHASHI, Shiojiri (JP); Kosuke CHIDATE, Shiojiri (JP)

(21) Appl. No.: 16/851,224

(22) Filed: Apr. 17, 2020

(30) Foreign Application Priority Data
Apr. 19, 2019 (JP) 2019-080224

(51) Int. Cl. C09D 11/322; C09D 11/107

(52) U.S. Cl. CPC C09D 11/322; C08K 5/3415; C09D 11/107

(57) ABSTRACT

An ink jet printing ink composition includes: cross-linkable group-containing urethane resin particles; a diketopyrrolopyrrole-based pigment; and a first organic solvent having a hydrogen bond term δh of 10 to less than 18 in Hansen solubility parameters.

The present application is based on, and claims priority from JP Application Serial Number 2019-080224, filed Apr. 19, 2019, the disclosure of which is hereby incorporated by reference herein in its entirety.

### BACKGROUND

### 1. Technical Field

The present disclosure relates to an ink jet printing ink composition and an ink jet printing method.

### 2. Related Art

An ink jet recording method is a method in which small droplets of an ink composition are ejected from a fine nozzle and are then adhered to a recording medium for recording. This method has a feature to rapidly record a high-quality image with a high resolution using a relatively inexpensive apparatus. In the ink jet recording method, there have been a significantly large number of items to be investigated, such as properties of an ink composition to be used, stability during recording, and quality of an image to be obtained, and hence, research has been intensively carried out not only on an ink jet recording apparatus but also on an ink jet ink to be used.

In addition, by the use of the ink jet recording method, dyeing (printing) of a cloth or the like has also been carried out. In the past, as a printing method performed on a cloth (such as a woven cloth or a non-woven cloth), although a screen printing method, a roller printing method, or the like has been used, since having various advantages in terms of production of many types in small quantity, immediate printability, and the like, the ink jet recording method has been investigated from many various angles.

For example, as disclosed in JP-A-2018-53171, as a printing ink jet ink composition not only excellent in friction fastness and color development of an image to be formed but also excellent in storage stability with a small change in viscosity during storage, a printing ink jet ink composition containing a self-dispersion type pigment having hydrophilic groups on its surface and an urethane-based resin dispersion having cross-linkable groups has been proposed.

As disclosed in JP-A-2018-53171, when an ink composition contains cross-linkable group-containing urethane resin particles, and when this ink composition is ejected by an ink jet method so as to be adhered to a recording medium, such as a cloth, a reaction occurs with a surface of the recording medium, and hence, friction fastness can be enhanced. However, in order to enhance color development of a printed material, when a diketopyrrolopyrrole-based pigment is used with the resin particles described above in combination, it was found that this pigment is liable to aggregate in the ink composition, and the ejection stability thereof becomes a problem.

### SUMMARY

The present inventors carried out intensive research to solve the problem described above. As a result, it was found that when an ink jet printing ink composition containing predetermined cross-linkable group-containing urethane resin particles, a diketopyrrolopyrrole-based pigment, and a first organic solvent having a predetermined hydrogen bond term δh in combination is used, an ink jet printing ink composition and an ink jet printing method, each of which is excellent not only in color development but also excellent in friction fastness of a printed material and ejection stability, can be obtained.

That is, the present disclosure relates to an ink jet printing ink composition which contains: cross-linkable group-containing urethane resin particles; a diketopyrrolopyrrole-based pigment; and a first organic solvent having a hydrogen bond term δh of 10 to less than 18 in Hansen solubility parameters.

In addition, the present disclosure also relates to an ink jet printing method which comprises: an ink adhesion step of ejecting an ink jet printing ink composition by an ink jet method to be adhered to a recording medium, and the ink jet printing ink composition contains: cross-linkable group-containing urethane resin particles; a diketopyrrolopyrrole-based pigment; and a first organic solvent having a hydrogen bond term δh of 10 to less than 18 in Hansen solubility parameters.

In the ink jet printing ink composition and the ink jet printing method described above, the following is preferable. The cross-linkable group-containing urethane resin particles preferably have a glass transition temperature of 5° C. or less. The first organic solvent preferably includes an alcohol-based solvent or an ether-based solvent. The ink jet printing ink composition preferably contains a second organic solvent having a hydrogen bond term δh of less than 10. The second organic solvent preferably includes a cyclic lactam. The ink jet printing ink composition contains a lubricant.

### DESCRIPTION OF EXEMPLARY EMBODIMENTS

Hereinafter, although an embodiment (hereinafter, referred to as “this embodiment”) of the present disclosure will be described in detail, the present disclosure is not limited thereto and may be variously changed and/or modified without departing from the scope of the present disclosure.

### Ink Jet Printing Ink Composition

An ink jet printing ink composition (hereinafter, simply referred to as “ink composition” in some cases) of this embodiment contains: cross-linkable group-containing urethane resin particles; a diketopyrrolopyrrole-based pigment; and a first organic solvent (hereinafter, simply referred to as “first organic solvent” in some cases) having a hydrogen bond term δh of 10 to less than 18 in Hansen solubility parameters.

By the structure described above, while being excellent in color development, the ink composition is excellent in friction fastness of a printed material and ejection stability.

### —Cross-Linkable Group-Containing Urethane Resin Particles—

The ink composition of this embodiment contains the cross-linkable group-containing urethane resin particles (hereinafter, simply referred to as “resin particles” in some cases). Although the resin particles are not particularly limited, for example, resin particles obtained by blending a dispersion liquid of resin particles with an ink composition may be mentioned. The resin particles contain an urethane-based resin having cross-linkable groups.

The cross-linkable groups may be groups forming a cross-linked structure by a reaction therebetween or may be groups forming a cross-linked structure by a reaction between the cross-linkable group and a functional group different therefrom.

The urethane-based resin contained in the resin particles preferably has at least three cross-linkable groups in one molecule. Accordingly, the cross-linked structure is likely to be formed by the reaction between the cross-linkable groups. In addition, in this specification, the “urethane-based resin” indicates a resin having intramolecular urethane bonds. In consideration of storage stability of an ink, and in addition, when a polyvalent metal compound is contained in a treatment liquid which will be described later, in consideration of improvement in reactivity with the polyvalent metal compound, the urethane-based resin is preferably an anionic urethane-based resin having anionic functional groups, such as a carboxyl group, a sulfo group, and/or a hydroxy group.

Although the urethane-based resin is not particularly limited, for example, there may be mentioned a polyether type urethane resin containing an urethane bond and an ether bond, a polyester type urethane resin containing an urethane bond and an ester bond, or a polycarbonate type urethane resin containing an urethane bond and a carbonate bond. Those urethane resins may be used alone, or at least two types thereof may be used in combination.

The weight average molecular weight of the urethane-based resin contained in the resin particles is preferably 1,000 to 100,000, more preferably 1,000 to 10,000, and further preferably 1,000 to 5,000. The weight average molecular weight may be measured on a polystyrene basis by a gel permeation chromatography (GPC) using tetrahydrofuran as a solvent.

Although the cross-linkable group contained in the cross-linkable group-containing urethane resin particles is not particularly limited, for example, a blocked isocyanate group, a silanol group, or a silanol group protected by a protective group may be mentioned. Although the silanol group is not particularly limited, for example, a triethoxysilyl group, a trimethoxysilyl group, or a tris(2-methoxy ethoxy)silyl group may be mentioned. As the cross-linkable group, a blocked isocyanate group is preferable in terms of storage stability and reactivity. As the blocked isocyanate, groups similar to those described later as cross-linking agents may be used. Since the resin has cross-linkable groups, a cross-linked structure is formed, for example, between particles of the resin, and hence, the friction fastness can be improved.

Although a commercially available product of a dispersion of the cross-linkable group-containing urethane resin particles is not particularly limited, for example, there may be mentioned “Takelac WS-6021” (product name, manufactured by Mitsui Chemicals Inc., emulsion of a polyether type polyurethane resin having a polyether-derived skeleton), “Takelac WS-5100” (product name, manufactured by Mitsui Chemicals Inc., emulsion of a polycarbonate type polyurethane resin having a polycarbonate-derived skeleton), “H-38”, “BAP”, “C-52”, “F-29”, and “W-11P” of “Elastron” Series (product names, manufactured by DKS Co., Ltd.), “E-37” and “H-3” of “Elastron” Series (product names, manufactured by DKS Co., Ltd., emulsion of a polyester type polyurethane resin having a polyester-derived skeleton), “870”, “800”, “150”, “420”, “460”, “470”, “610”, and “700” of “Superflex” Series (product names, manufactured by DKS Co., Ltd., emulsion of an urethane-based resin), “Permarin UA-150” (product name, manufactured by Sanyo Chemical Industries, Ltd., emulsion of an urethane-based resin), “Suncure 2710” (product name, manufactured by Nippon Lubrizol, emulsion of an urethane-based resin), “R-9660”, “R-9637”, and “R-940” of “NeoRez” Series (product names, manufactured by Kusumoto Chemicals, Ltd., emulsion of an urethane-based resin), “HUX-380” and “290K” of “Adeka Bontighter” Series (product names, manufactured by ADEKA Corporation, emulsion of an urethane-based resin), and “Eternacoll UW-1501F” (product name, manufactured by Ube Industries, Ltd., emulsion of an urethane-based resin).

The glass transition temperature of the cross-linkable group-containing urethane resin particles is preferably 5° C. or less, more preferably 0° C. or less, further preferably −10° C. or less, and particularly preferably −20° C. or less. The glass transition temperature of the cross-linkable group-containing urethane resin particles is preferably −100° C. or more, more preferably −60° C. or more, and further preferably −40° C. or more. When the glass transition temperature is in the range described above, the texture of the printed material preferably tends to be improved. The glass transition temperature of the resin particles may be measured in accordance with JIS K7121: 1987 using a differential scanning heat calorimetry (DSC). As a differential scanning calorimeter, for example, “DSC6220” (product name, manufactured by Seiko Electron Co., Ltd.) may be mentioned.

The content of the cross-linkable group-containing urethane resin particles is with respect to the total mass of the ink composition, preferably 1 to 20 percent by mass, more preferably 3 to 15 percent by mass, and further preferably 5 to 12 percent by mass. In addition, the content described above is particularly preferably 7 to 10 percent by mass.

### —Cross-Linking Agent—

The ink composition of this embodiment may also contain a cross-linking agent. As the cross-linking agent, a blocked isocyanate compound is preferable. The blocked isocyanate compound is a chemically protected isocyanate and contains a latent isocyanate group in which an isocyanate group is protected by a blocking agent.

The blocked isocyanate compound may be obtained, for example, by a reaction between a polyisocyanate compound and a blocking agent. Since the cross-linking agent as described above is contained, when the ink composition is stored, cross linking is not likely to proceed, and after the printing, since deprotection is performed by heating, the cross linking proceeds, so that an excellent friction fastness can be obtained. Since the isocyanate group protected by the protective group is deprotected and activated by heating, a chemical bond, such as an urethane bond, an urea bond, an allophanate bond, a biuret bond, or an isocyanurate bond, is formed.

Although the polyisocyanate compound to be used for manufacturing of the blocked isocyanate compound is not particularly limited, for example, a polyisocyanate monomer or a polyisocyanate derivative may be mentioned.

Although the polyisocyanate monomer is not particularly limited, for example, there may be mentioned a polyisocyanate having an aromatic ring, an aliphatic polyisocyanate, or an alicyclic polyisocyanate. Those polyisocyanate monomers may be used alone, or at least two types thereof may be used in combination.

Although the polyisocyanate having an aromatic ring is not particularly limited, for example, there may be mentioned tolylene diisocyanate, xylylene diisocyanate, or diphenylmethane diisocyanate. Although the aliphatic polyisocyanate is not particularly limited, for example, hexamethylene diisocyanate may be mentioned. Although the alicyclic polyisocyanate is not particularly limited, for example, hydrogenated xylylene diisocyanate, isophorone diisocyanate, or dicyclohexylmethane diisocyanate may be mentioned.

As the polyisocyanate derivative, for example, there may be mentioned a multimer (such as a dimer, a trimer (such as an isocyanurate modified compound or an iminooxadiazinedione modified compound), a pentamer, or a heptamer) of the polyisocyanate monomer mentioned above; an allophanate modified compound (such as an allophanate modified compound obtained by a reaction between the polyisocyanate monomer mentioned above and a low molecular weight polyol which will be described later), a polyol modified compound (such as a polyol modified compound (alcohol adduct) obtained by a reaction between a polyisocyanate monomer and the low molecular weight polyol which will be described later), a burette modified compound (such as a burette modified compound obtained by a reaction between the polyisocyanate monomer mentioned above and water and/or an amine), an urea modified compound (such as an urea modified compound obtained by a reaction between the polyisocyanate monomer mentioned above and a diamine), an oxadiazinetrione modified compound (such as oxadiazinetrione obtained by a reaction between the polyisocyanate monomer mentioned above and carbon dioxide), a carbodiimide modified compound (such as a carbodiimide modified compound obtained by a decarboxylation condensation reaction of the polyisocyanate monomer mentioned above), an uretdione modified compound, or an uretonimine modified compound.

In addition, when at least two types of polyisocyanate compounds are used in combination, for example, in the manufacturing of the blocked isocyanate compound, at least two types of polyisocyanate compounds may be allowed to simultaneously react, or blocked isocyanate compounds separately obtained by using the respective polyisocyanate compounds may be mixed together.

The blocking agent not only blocks an isocyanate group for deactivation but also functions to regenerate or activate the isocyanate group by deblocking. Although the blocking agent is not particularly limited, for example, there may be mentioned an imidazole-based compound, an imidazoline-based compound, a pyrimidine-based compound, a guanidine-based compound, an alcohol-based compound, a phenol-based compound, an activated methylene-based compound, an amine-based compound, an imine-based compound, an oxime-based compound, a carbamic acid-based compound, an urea-based compound, an acid amide-based (lactam-based) compound, an acid imide-based compound, a triazole-based compound, a pyrazole-based compound, a mercaptan-based compound, a bisulfite, benzoxazolone, isatoic anhydride, or tetrabutylphosphonium acetate.

Although the imidazole-based compound is not particularly limited, for example, there may be mentioned imidazole (dissociation temperature: 100° C.), benzimidazole (dissociation temperature: 120° C.), 2-methylimidazole (dissociation temperature: 70° C.), 4-methylimidazole (dissociation temperature: 100° C.), 2-ethylimidazole (dissociation temperature: 70° C.), 2-isopropylimidazole, 2,4-dimethylimidazole, or 2-ethyl-4-methylimidazole.

Although the imidazoline-based compound is not particularly limited, for example, 2-methylimidazoline (dissociation temperature: 110° C.) or 2-phenylimidazoline may be mentioned.

Although the pyrimidine-based compound is not particularly limited, for example, 2-metyl-1,4,5,6-tetrahydropyrimidine may be mentioned.

Although the guanidine-based compound is not particularly limited, for example, there may be mentioned guanidine, a 3,3-dialkylguanidine, such as 3,3-dimethylguanidine, a 1,1,3,3-tetraalkylguanidine, such as 1,1,3,3-tetramethylguanidine (dissociation temperature: 120° C.), or 1,5,7-triazabicyclo[4,4,0]deca-5-ene.

Although the alcohol-based compound is not particularly limited, for example, there may be mentioned methanol, ethanol, 2-propanol, n-butanol, s-butanol, 2-ethylhexyl alcohol, 1- or 2-octanol, cyclohexyl alcohol, ethylene glycol, benzyl alcohol, 2,2,2-trifluoroethanol, 2,2,2-trichloroethanol, 2-(hydroxymethyl)furan, 2-methoxyethanol, methoxypropanol, 2-ethoxyethanol, n-propoxyethanol, 2-butoxyethanol, 2-ethoxyethoxyethanol, 2-ethoxybutoxyethanol, butoxyethoxyethanol, 2-butoxyethylethanol, 2-butoxyethoxyethanol, N,N-dibutyl-2-hydroxyacetoamide, N-hydroxysuccinimide, N-morpholineethanol, 2,2-dimethyl-1,3-dioxolane-4-methanol, 3-oxazolineethanol, 2-hydroxymethylpyridine (dissociation temperature: 140° C.), furfuryl alcohol, 12-hydroxystearylic acid, triphenylsilanol, or 2-hydroxyethyl methacrylate.

Although the phenol-based compound is not particularly limited, for example, there may be mentioned phenol, cresol, ethylphenol, n-propylphenol, isopropylphenol, n-butylphenol, sec-butylphenol, tert-butylphenol, n-hexylphenol, 2-ethylhexylphenol, n-octylphenol, n-nonylphenol, di-n-propylphenol, diisopropylphenol, isopropylcresol, di-n-butylphenol, di-sec-butylphenol, di-tert-butylphenol, di-n-octylphenol, di-2-ethylhexylphenol, di-n-nonylphenol, dimethylphenol, styrenated phenol, methyl salicylate, 4-hydroxymethylbenzoate, 4-hydroxybenzylbenzoate, hydroxy 2-ethylhexylbenzoate, 4-[(dimethylamino)methyl]phenol, 4-(dimethylamino)methyl]nonylphenol, bis(4-hydroxyphenyl)acetic acid, 2-hydroxypyridine (dissociation temperature: 80° C.), 2- or 8-hydroxyquinoline, 2-chloro-3-pyridinol, or pyridine-2-thiol (dissociation temperature: 70° C.)

Although the activated methylene-based compound is not particularly limited, for example, there may be mentioned Meldrum's acid, a malonic acid diester, an acetoacetic ester, 2-acetoacetoxyethyl methacrylate, acetylacetone, or a cyanoacetic acid ester. Although the malonic acid diester is not particularly limited, for example, there may be mentioned dimethyl malonate, diethyl malonate, di-n-butyl malonate, di-tert-butyl malonate, di-2-ethylhexyl malonate, methyl n-butyl malonate, ethyl n-butyl malonate, methyl sec-butyl malonate, ethyl sec-butyl malonate, methyl tert-butyl malonate, ethyl tert-butyl malonate, diethyl methylmalonate, dibenzyl malonate, diphenyl malonate, benzyl methyl malonate, ethyl phenyl malonate, tert-butyl phenyl malonate, or isopropylidene malonate. Although the acetoacetic ester is not particularly limited, for example, there may be mentioned methyl acetoacetate, ethyl acetoacetate, n-propyl acetoacetate, isopropyl acetoacetate, n-butyl acetoacetate, t-butyl acetoacetate, benzyl acetoacetate, or phenyl acetoacetate.

Although the amine-based compound is not particularly limited, for example, there may be mentioned dibutylamine, diphenylamine, aniline, N-methylaniline, carbazole, bis(2,2,6,6-tetramethylpyperidinyl)amine, di-n-propylamine, diisopropylamine (dissociation temperature: 130° C.), isopropylethylamine, 2,2,4- or 2,2,5-trimethylhexamethyleneamine, N-isopropylcyclohexylamine (dissociation temperature: 140° C.), dicyclohexylamine (dissociation temperature: 130° C.), bis(3,5,5-trimethylcyclohexyl) amine, piperidine, 2,6-dimethylpyperidine (dissociation temperature: 130° C.), tert-butylmethylamine, tert-butylethylamine (dissociation temperature: 120° C.), tert-butylpropylamine, tert-butylbutylamine, tert-butylbenzylamine (dissociation temperature: 120° C.), tert-butylphenylamine, 2,2,6-trimethylpyperidine, 2,2,6,6-tetramethylpyperidine (dissociation temperature: 80° C.), (dimethylamino)-2,2,6,6-tetramethylpyperidine, 2,2,6,6-tetramethyl-4-pyperidine, 6-methyl-2-pyperidine, or 6-aminocaploric acid.

Although the imine-based compound is not particularly limited, for example, ethyleneimine, a polyethyleneimine, or 1,4,5,6-tetrahydropyrimidine may be mentioned.

Although the oxime-based compound is not particularly limited, for example, there may be mentioned formaldoxime, acetoaldoxime, acetoxime, methyl ethyl ketoxime (dissociation temperature: 130° C.), cyclohexanone oxime, diacetylmonoxime, benzophenoxime, 2,2,6,6-tetramethylcyclohexanone oxime, diisopropyl ketone oxime, methyl tert-butyl ketone oxime, diisobutyl ketone oxime, methyl isobutyl ketone oxime, methyl isopropyl ketone oxime, methyl 2,4-dimethylpentyl ketone oxime, methyl 3-ethylheptyl ketone oxime, methyl isoamyl ketone oxime, n-amyl ketone oxime, 2,2,4,4-tetramethyl-1,3-cyclobutanedione monoxime, 4,4′-dimethoxy benzophenone oxime, or 2-heptanone oxime.

Although the carbamic acid-based compound is not particularly limited, for example, N-phenyl phenylcarbamate may be mentioned.

Although the urea-based compound is not particularly limited, for example, there may be mentioned urea, thiourea, or ethylene urea.

Although the acid amide-based (lactam-based) compound is not particularly limited, for example, there may be mentioned acetanilide, N-methylacetanilide, amide acetate, ε-caprolactam, 8-valerolactam, y-butyrolactam, pyrrolidone, 2,5-piperazinedione, or laurolactam.

Although the acid imide-based compound is not particularly limited, for example, there may be mentioned succinimide, maleimide, or phthalimide.

Although the triazole-based compound is not particularly limited, for example, 1,2,4-tirazole or benzotriazole may be mentioned.

Although the pyrazole-based compound is not particularly limited, for example, there may be mentioned pyrazole, 3,5-dimethylpyrazole (dissociation temperature: 120° C.), 3,5-diisopropylpyrazole, 3,5-diphenylpyrazole, 3,5-di-tert-butylpyrazole, 3-methylpyrazole, 4-benzyl-3,5-dimethylpyrazole, 4-nitro-3,5-dimethylpyrazole, 4-bromo-3,5-dimethylpyrazole, or 3-methyl-5-phenylpyrazole.

Although the mercaptan-based compound is not particularly limited, for example, there may be mentioned butyl mercaptan, dodecyl mercaptan, or hexyl mercaptan.

Although the bisulfite is not particularly limited, for example, sodium bisulfite may be mentioned.

Those blocking agents may be used alone, or at least two types thereof may be used in combination. In addition, the dissociation temperatures of some of the compounds mentioned above are also shown as a temperature at which the isocyanate group is regenerated.

The dissociation temperature of the blocking agent is preferably 60° C. to 230° C., more preferably 80° C. to 200° C., further preferably 100° C. to 180° C., and particularly preferably 110° C. to 160° C. When the dissociation temperature is in the range described above, the storage stability of the ink composition can be further improved, and in addition, the temperature in a heating step can be set to be lower.

Although commercially available products of the blocking agents described above are not particularly limited, for example, there may be mentioned “Takenate WB-3021” (product name, manufactured by Mitsui Chemicals Inc.), “BN-69” and “11” of “Elastron” Series (product names, manufactured by DKS Co., Ltd.), and “SU-268A”, “NBP-8730”, and “NBP-211” (product names, manufactured by Meisei Chemical Works, Ltd.). Those blocking agents may be used alone, or at least two types thereof may be used in combination.

When the cross-linking agent is contained, the content thereof is preferably 1 to 100 parts by mass with respect to 100 parts by mass of the cross-linkable group-containing urethane resin particles. Since the content of the cross-linking agent is in the range described above, the friction fastness of the printed material can be improved. The content of the cross-linking agent is more preferably 10 percent by mass or more and further preferably 20 percent by mass or more. The content of the cross-linking agent is more preferably 80 percent by mass or less and further preferably 50 percent by mass or less.

### —Diketopyrrolopyrrole-Based Pigment—

The ink composition of this embodiment contains the diketopyrrolopyrrole-based pigment. Since the diketopyrrolopyrrole-based pigment is contained, the ink composition shows an excellent color development of the printed material. The diketopyrrolopyrrole-based pigment is not particularly limited as long as having a diketopyrrolopyrrole skeleton, and a pigment having a substituent, such as an alkyl group, in the diketopyrrolopyrrole skeleton and a pigment having no substituent therein may both be used.

Although the diketopyrrolopyrrole-based pigment is not particularly limited, for example, there may be mentioned a diketopyrrolopyrrole-based pigment which shows a red color or a diketopyrrolopyrrole-based pigment which shows an orange color. Among those mentioned above, the diketopyrrolopyrrole-based pigment is preferably a diketopyrrolopyrrole-based pigment which shows a red color. In addition, the “which shows a red color” indicates that, when a printed material formed by coating the entire surface of a white recording medium with the ink jet composition is measured using Spectrolino (manufactured by Gretag-Macbeth AG), h in the L*C*h color space of the CIE standard colorimetric system is in a range of from −30° to 45°, and in addition, h is preferably in a range of from −30° to 32°, more preferably in a range of from −30° to 30°, and further preferably in a range of from −30° to 25°.

Although the diketopyrrolopyrrole-based pigment which shows a red color is not particularly limited, for example, there may be mentioned C.I. Pigment Red 254, C.I.

Pigment Red 255, C.I. Pigment Red 264, C.I. Pigment Red 270, or C.I. Pigment Red 272. Although the diketopyrrolopyrrole-based pigment which shows an orange color is not particularly limited, for example, there may be mentioned C.I. Pigment Orange 71, C.I. Pigment Orange 73, or C.I. Pigment Orange 81. Among those mentioned above, in order to obtain a printed material showing a more excellent color development, C.I. Pigment Red 254, C.I. Pigment Red 255, or C.I. Pigment Red 264 is preferable, C.I. Pigment Red 254 or C.I. Pigment Red 255 is more preferable, and C.I. Pigment Red 254 is further preferable. Those diketopyrrolopyrrole-based pigments may be used alone, or at least two types thereof may be used in combination.

The content of the diketopyrrolopyrrole-based pigment is with respect to the total mass of the ink composition, preferably 0.5 to 15.0 percent by mass, more preferably 1.0 to 10.0 percent by mass, further preferably 2.0 to 7.0 percent by mass, and particularly preferably 2.5 to 4.5 percent by mass. Since the content of the diketopyrrolopyrrole-based pigment is 0.5 percent by mass or more, the color development of a printed material to be obtained is further improved. Since the content of the diketopyrrolopyrrole-based pigment is 15.0 percent by mass or less, the storage stability and the ejection stability of a printed material to be obtained are further improved.

The pigment contained in the ink composition of this embodiment may be a mixture of the diketopyrrolopyrrole-based pigment and a pigment (hereinafter, referred to as “another pigment” in some cases) different from the diketopyrrolopyrrole-based pigment. Although the another pigment is not particularly limited, for example, either an inorganic pigment or an organic pigment may be used.

Although the organic pigment is not particularly limited, for example, there may be mentioned an azo pigment(such as an azo lake, an insoluble azo pigment, a condensed azo pigment, or a chelate azo pigment), a polycyclic pigment (such as a phthalocyanine pigment, a perylene or a perylene pigment, an anthraquinone pigment, a quinacridone pigment, a dioxazine pigment, a thioindigo pigment, an isoindoline pigment, or a quinophthalone pigment), a dye lake (such as a basic dye type lake or an acidic dye type lake), a nitro pigment, a nitroso pigment, aniline black, or a daylight fluorescent pigment.

The ink composition of this embodiment preferably contains, as the another pigment, another organic pigment which shows a red color or another pigment which shows an orange color. Although the another organic pigment which shows a red color is not particularly limited, for example, there may be mentioned C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 170, C.I. Pigment Red 177, C.I. Pigment Red 178, C.I. Pigment Red 179, C.I. Pigment Red 194, C.I. Pigment Red 209, C.I. Pigment Red 222, or C.I. Pigment Red 224. Although the another organic pigment which shows an orange color is not particularly limited, for example, there may be mentioned C.I. Pigment Orange 31, C.I. Pigment Orange 43, or C.I. Pigment Orange 64.

Although the inorganic pigment is not particularly limited, for example, there may be mentioned carbon black, titanium dioxide, silica, or alumina.

The content of the diketopyrrolopyrrole-based pigment is with respect to the total mass of the pigment, preferably 30 to 100 percent by mass, more preferably 50 to 100 percent by mass, and further preferably 70 to 100 percent by mass. When the content of the diketopyrrolopyrrole-based pigment is set in the range described above, by the ink composition, the color development of the printed material can be further improved.

### —First Organic Solvent—

The ink composition of this embodiment at least contains the first organic solvent (hereinafter, simply referred to as “first organic solvent” in some cases) having a hydrogen bond term δh (hereinafter, simply referred to as “δh” in some cases) of 10 to less than 18 in Hansen solubility parameters. Since containing the first organic solvent, the ink composition of this embodiment shows an excellent ejection stability. Although the reason for this is not fully understood, the present inventors believe as described below. Since containing the diketopyrrolopyrrole-based pigment, although the ink composition of this embodiment shows an excellent color development, the diketopyrrolopyrrole-based pigment has a problem in terms of dispersion stability, and as a result, aggregates may be generated in some cases. In addition, since the ink composition of this embodiment contains the cross-linkable group-containing urethane resin particles, due to the reaction of the cross-linkable groups and to the presence of low molecular weight resin components which are unstably dispersed in the resin particles, aggregates may be generated in the ink composition in some cases. Since the first organic solvent has a high solubility of the low molecular weight resin components and also improves the dispersion stability of the diketopyrrolopyrrole-based pigment, the ink composition of this embodiment is believed to have an excellent ejection stability.

——δh——

δh indicates the hydrogen bond term in Hansen solubility parameters.

As the hydrogen bond term in Hansen solubility parameters used in this embodiment, the value disclosed in “HANSEN SOLUBILITY PARAMETERS A User's Handbook Second Edition” is used. As for a solvent not disclosed in the above handbook, the hydrogen bond term thereof may be determined in accordance with Hansen solubility parameters in Practice (HSPiP) program (second edition). The hydrogen bond term in Hansen solubility parameters in this specification is a value obtained at 25° C.

Although the first organic solvent is not particularly limited, for example, an alcohol-based solvent or an ether-based solvent may be mentioned. Among those mentioned above, the ether-based solvent is preferable.

As the ether-based solvent, a glycol ether is preferable, and a glycol monoether having one or two hydroxy groups is more preferable. Although the ether-based solvent is not particularly limited, for example, there may be mentioned tetraethylene glycol (δh=15.3), ethylene glycol monomethyl ether, ethylene glycol monoethyl ether, ethylene glycol mono-n-propyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, ethyl hexyl diglycol (δh=10.0), triethylene glycol monobutyl ether (δh=10.9, hereinafter, referred to as “TEGmBE” in some cases), triethylene glycol monoethyl ether, triethylene glycol monomethyl ether (δh=12.5, hereinafter, referred to as “TEGmME” in some cases), tetraethylene glycol monomethyl ether, tetraethylene glycol monoethyl ether, propylene glycol monomethyl ether, propylene glycol monoethyl ether, dipropylene glycol monomethyl ether, or dipropylene glycol monoethyl ether. Among those mentioned above, triethylene glycol monobutyl ether or triethylene glycol monomethyl ether may be preferable.

As the alcohol-based solvent, an alcohol having 5 to 20 carbon atoms and one or two hydroxy groups is preferable, and a linear aliphatic alcohol having 5 to 12 carbon atoms and two hydroxy groups is preferable. Although the alcohol-based solvent is not particularly limited, for example, there may be mentioned 1,2-hexanediol (δh=17.1), N,N-dimethylglycine (δh=13.4), 1,6-hexanediol (δh=17.8), 1,9-nonanediol (δh=15.1), 2,5-hexanediol (δh=17.6), or 2-methyl-2-propyle-1,3-propanediol (δh=14.6). Among those mentioned above, 1,2-hexanediol is preferable.

The content of the first organic solvent is with respect to the total mass of the ink composition, preferably 0.1 to 10.0 percent by mass, more preferably 0.5 to 6.0 percent by mass, and further preferably 1.0 to 4.0 percent by mass. Since the content of the first organic solvent is 0.1 percent by mass or more, the storage stability and the ejection stability of the ink composition are improved. Since the content of the first organic solvent is 10.0 percent by mass or less, the color development of the ink composition is improved.

### —Second Organic Solvent—

The ink composition of this embodiment preferably further contains a second organic solvent (hereinafter, simply referred to as “second organic solvent” in some cases) having a δh of less than 10. Since containing the second organic solvent, the ink composition of this embodiment may further improve the ejection stability.

Although the second organic solvent is not particularly limited, for example, there may be mentioned a lactam-based solvent, a glycol diether-based solvent, or a glycol monoether acetate-based solvent. Among those mentioned above, the lactam-based solvent is preferable.

Although the lactam-based solvent is not particularly limited, for example, there may be mentioned 2-pyrolidone (δh=9.0), an N-alkyl-2-pyrrolidone, a 1-alkyl-2-pyrrolidone, or ε-caprolactam.

Although the glycol diether-based solvent is not particularly limited, for example, there may be mentioned diethylene glycol diethyl ether (δh=5.6, hereinafter, referred to as “DEGDEE” in some cases), ethylene glycol dimethyl ether, ethylene glycol diethyl ether, ethylene glycol dibutyl ether, diethylene glycol dimethyl ether, diethylene glycol diethyl ether, diethylene glycol ethyl methyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, or dipropylene glycol diethyl ether.

Although the glycol monoether acetate-based solvent is not particularly limited, for example, there may be mentioned diethylene glycol monomethyl ether acetate, diethylene glycol monoethyl ether acetate, or diethylene glycol monobutyl ether acetate (δh=8.2, hereinafter, referred to as “BCA” in some cases).

Among those second organic solvents, 2-pyrrolidone, diethylene glycol diethyl ether, or diethylene glycol monobutyl ether acetate is preferable, and 2-pyrrolidone is more preferable.

When the ink composition of this embodiment contains the second organic solvent, the content thereof is with respect to the total mass of the ink composition, preferably 0.1 to 10.0 percent by mass, more preferably 0.5 to 4.0 percent by mass, and further preferably 1.0 to 2.0 percent by mass. Since the content of the second organic solvent is 0.1 percent by mass or more, the storage stability and the ejection stability of the ink composition are improved. Since the content of the second organic solvent is 10.0 percent by mass or less, the storage stability and the color development of the ink composition are improved.

### —Third Organic Solvent—

The ink composition of this embodiment preferably further contains a third organic solvent (hereinafter, simply referred to as “third organic solvent” in some cases) having a δh of 18 or more. Since containing the third organic solvent, the ink composition of this embodiment may further improve the color development.

Although the third organic solvent is not particularly limited, for example, there may be mentioned a monoalcohol having 1 to 4 carbon atoms, a dialcohol having 1 to 4 carbon atoms, or a trialcohol having 1 to 10 carbon atoms. Among those mentioned above, the trialcohol having 1 to 10 carbon atoms is preferable.

Although the monoalcohol having 1 to 4 carbon atoms is not particularly limited, for example, there may be mentioned methanol, ethanol, n-propyl alcohol, isopropyl alcohol, n-butanol, 2-butanol, tert-butanol, or isobutanol.

Although the dialcohol having 1 to 4 carbon atoms is not particularly limited, for example, there may be mentioned ethylene glycol (oh=26.0), diethylene glycol (δh=19.0), triethylene glycol (δh=18.6), 1,3-propanediol (δh=23.2), 2-methyl-1,3-propanediol (δh=20.7), or 1,4-butanediol (δh=20.9). Although the trialcohol having 1 to 10 carbon atoms is not particularly limited, for example, there may be mentioned glycerin (δh=23.0), triethanolamine (δh=21.0, hereinafter, referred to as “TEA” in some cases), trimethylolpropane (δh=21.1, hereinafter, referred to as “TMP” in some cases), or trimethylolethane (δh=23.1).

When the ink composition of this embodiment contains the third organic solvent, the content thereof is with respect to the total mass of the ink composition, preferably 1.0 to 30.0 percent by mass, more preferably 3.0 to 20.0 percent by mass, and further preferably 5.0 to 15.0 percent by mass.

### —Water—

The ink composition of this embodiment is preferably an aqueous ink containing water. In this case, the “aqueous ink composition” indicates an ink composition containing 30 percent by mass or more of water with respect to the total mass of the ink composition. Although the water is not particularly limited, for example, there may be mentioned pure water, such as ion-exchanged water, ultrafiltration water, reverse osmosis water, or distilled water, or ultrapure water.

The content of the water in the ink composition of this embodiment is with respect to the total mass of the ink composition, preferably 30.0 to 90.0 percent by mass, more preferably 40.0 to 85.0 percent by mass, and further preferably 50.0 to 80.0 percent by mass.

### —Surfactant—

In order to stably eject an ink composition by an ink jet recording method, and in order to appropriately control the permeation of the ink composition, the ink composition of this embodiment preferably further contains a surfactant. Although the surfactant is not particularly limited, for example, an acetylene-based surfactant, a fluorine-based surfactant, or a silicone-based surfactant may be mentioned.

Although the acetylene-based surfactant is not particularly limited, for example, there may be mentioned 2,4,7,9-etramethyl-5-decyne-4,7-diol, an alkylene oxide adduct thereof, 2,4-dimethyl-5-decyne-4-ol, or an alkylene oxide adduct thereof. Those may be used alone, or at least two types thereof may be used in combination.

Although a commercially available product of the acetylene glycol-based surfactant is not particularly limited, for example, there may be mentioned “Olfine 104” or “Olfine E1010” (product name, manufactured by Air Products) or “465”, “61”, or “DF110D” of “Surfynol” Series (product name, manufactured by Nisshin Chemical Industry Co., Ltd.).

Although the fluorine-based surfactant is not particularly limited, for example, there may be mentioned a perfluoroalkyl sulfonic acid salt, a perfluoroalkyl carboxylic acid salt, a perfluoroalkyl phosphoric acid ester, a perfluoroalkyl ethylene oxide adduct, a perfluoroalkyl betaine, or a perfluoroalkyl amine oxide compound. Those mentioned above may be used alone, or at least two types thereof may be used in combination.

Although a commercially available product of the fluorine-based surfactant is not particularly limited, for example, there may be mentioned “S144” or “S145” of “Surflon” Series (product name, manufactured by AGC SEIMI CHEMICAL CO., LTD.), “FC-170C”, “FC-430”, or “Florard FC4430” (trade name, manufactured by Sumitomo 3M Limited), “FSO”, “FSO-100”, “FSN”, “FSN-100”, or “FS-300” (product name, manufactured by Du pont), or “FT-250” or “FT-251” (product name, manufactured by Neos Co., Ltd.). Those mentioned above may be used alone, or at least two types thereof may be used in combination.

Although the silicone-based surfactant is not particularly limited, for example, a polysiloxane-based compound or a polyether-modified organosiloxane may be mentioned. Those may be used alone, or at least two types thereof may be used in combination.

Although a commercially available product of the silicone-based surfactant is not particularly limited, for example, there may be mentioned “BYK-306”, “BYK-307”, “BYK-333”, “BYK-341”, “BYK-345”, “BYK-346”, “BYK-347”, “BYK-348”, or “BYK-349” (product name, manufactured by BYK Additives Instruments), “KF-351A”, “KF-352A”, “KF-353”, “KF-354L”, “KF-355A”, “KF-615A”, “KF-945”, “KF-640”, “KF-642”, “KF-643”, “KF-6020”, “X-22-4515”, “KF-6011”, “KF-6012”, “KF-6015”, or “KF-6017” (product name, manufactured by Shin-Etsu Chemical Co., Ltd.).

When the ink composition of this embodiment contains the surfactant, the content thereof is with respect to the total mass of the ink composition, preferably 0.1 to 5.0 percent by mass, 0.2 to 3.0 percent by mass, and further preferably 0.2 to 1.0 percent by mass.

### —Lubricant—

In this embodiment, the ink composition preferably contains a lubricant. Since the ink composition contains a lubricant, the friction resistance of an image to be obtained is not only improved, but the texture of a cloth can also be maintained. In addition, the storage stability of the ink composition can also be improved. The reason for this is believed that since the lubricant is present in the ink composition, the cross-linkable group-containing urethane resin particles are suppressed from collision therebetween, and as a result, aggregates thereof are suppressed from being generated. As the lubricant, lubricant particles obtained as a dispersion liquid of the lubricant are preferably used. Although the lubricant is not particularly limited, for example, wax may be mentioned.

Although the wax is not particularly limited, for example, there may be mentioned a vegetable or animal wax, such as a carnauba wax, a candelilla wax, a bees wax, a rice wax, or a lanolin wax; a mineral wax, such as a montan wax or an ozokerite wax; a petroleum wax, such as a paraffin wax; a synthetic wax, such as a carbon wax, a Hoechst wax, a polyolefin wax, a silicone wax, or an amide stearate; a natural/synthetic wax emulsion, such as an U-olefin/maleic anhydride copolymer, or a compound wax. Those waxes may be used alone, or at least two types thereof may be used in combination. Among those waxes, the silicone wax, the polyolefin wax, or the paraffin wax is preferable.

When the ink composition of this embodiment contains a wax, the content thereof is with respect to the total mass of the ink composition, preferably 0.01 to 5.0 percent by mass, more preferably 0.1 to 3.0 percent by mass, and further preferably 0.5 to 2.0 percent by mass.

As other additives, the ink composition of this embodiment may appropriately contain various additives, such as a pH adjuster, a softening agent, a solubilizing agent, a viscosity adjuster, an antioxidant, a fungicide/antiseptic agent, a corrosion inhibitor, and a chelating agent (such as sodium ethylenediaminetetraacetate) to trap metal ions which adversely influence the dispersion.

A solid component concentration of the ink composition of this embodiment is preferably 8.0 percent by mass or more, more preferably 10.0 percent by mass or more, further preferably 12.0 percent by mass or more, and particularly preferably 15.0 percent by mass or more. Since the solid component concentration is in the range described above, the friction fastness and the degree of whiteness are further improved. The solid component concentration is preferably 30.0 percent by mass or less, more preferably 25.0 percent by mass or less, and further preferably 20.0 percent by mass or less. Since the solid component concentration is in the range described above, the ejection stability and the texture are further improved. In addition, the solid component concentration indicates the content of components other than the solvent including water.

In this embodiment, the ink composition can be obtained such that the components described above are mixed in an arbitrary order, followed by removing impurities, if needed, by filtration or the like. As a mixing method of the components, a method in which materials are sequentially added into a container equipped with a stirring device, such as a mechanical stirrer or a magnetic stirrer, may be preferably used. As the filtration method, for example, a centrifugal filtration or a filter filtration may be performed if needed.

### Ink Jet Printing Method

An ink jet printing method of this embodiment comprises an ink adhesion step (hereinafter, referred to as “adhesion step” in some cases) in which the above ink jet printing ink composition of this embodiment is ejected by an ink jet method so as to be adhered to a recording medium.

By the structure described above, while obtaining an excellent color development, the ink jet printing method improves the friction fastness of the printed material and the ejection stability.

The ink jet printing method described above is a printing method in which an ink composition is used after being charged in an ink jet apparatus. Although the ink jet apparatus described above is not particularly limited, for example, a drop-on-demand type ink jet apparatus may be mentioned. As this drop-on-demand type ink jet apparatus, for example, there may be used an apparatus using an ink jet printing method which uses a piezoelectric element provided in a head or an apparatus using an ink jet printing method which uses thermal energy generated by a heat generation resistant element, such as a heater, provided in a head, and any apparatus using one of the ink jet printing methods described above may be used. Hereinafter, each step of the ink jet printing method will be described in detail.

### —Adhesion Step—

The ink jet printing method of this embodiment ejects the above ink composition from a nozzle. The ink composition thus ejected is adhered to a cloth or the like. That is, in the ink jet printing method of this embodiment, a cloth may be used as a recording medium. In this embodiment, when an ink jet method is used in the adhesion step, for example, since a stencil necessary for analog printing, such as screen printing, is not required, the production of many types in small quantity is likely to be performed, and in addition, highly precise image, text, pattern, color, and the like can be formed.

### —Cloth—

Although fibers forming a cloth is not particularly limited, for example, there may be mentioned natural fibers, such as cotton, hemp, wool, or silk, synthetic fibers formed, for example, from a polypropylene, a polyester, an acetate, a triacetate, a polyamide, or a polyurethane, biodegradable fibers formed, for example, from a polylactic acid, or blend fibers formed from at least two of those fibers mentioned above.

As the cloth, the fibers mentioned above may be formed into a woven cloth, a knitted cloth, a non-woven cloth, or the like. In addition, although the weight per unit area of a cloth to be used in this embodiment is not particularly limited, for example, the weight per unit area thereof may be 1.0 to 10.0 Oz, preferably 2.0 to 9.0 Oz, more preferably 3.0 to 8.0 Oz, and further preferably 4.0 to 7.0 Oz. When the weight per unit area of the cloth is in the range described above, preferable recording can be performed. Furthermore, in the ink jet recording method of this embodiment, at least two types of cloths having different weights per unit area may also be used, and preferable printing can be performed.

As the form of the cloth of this embodiment, for example, there may be mentioned fabrics, clothing, and other accessories. As the fabrics, for example, a woven fabric, a knitted fabric, and a non-woven fabric may be mentioned. As the clothing and other accessories, for example, there may be mentioned sewn products, such as a T shirt, a handkerchief, a scarf, a towel, a handbag, and a cloth-made bag; furniture, such as a curtain, a sheet, a bed cover, and wallpaper; and cloths before and after cutting to be used as materials to be sewn. As the forms of those materials mentioned above, for example, there may be mentioned a material having a long roll shape, a material having a predetermined size by cutting, or a material having a product shape. In addition, a cloth processed in advance with a treatment liquid may also be used.

As the cloth, a cotton cloth dyed in advance by a dye may be used. As the dye which dyes the cloth in advance, for example, there may be mentioned an aqueous dye, such as an acidic dye or a basic dye, a dispersive dye using a dispersant, or a reactive dye. When a cotton cloth is used as the cloth, a reactive dye suitable for cotton dyeing is preferably used.

### —Treatment Liquid—

In this embodiment, the cloth is preferably processed by a treatment liquid composition (hereinafter, simply referred to as “treatment liquid” in some cases”). When ink jet printing is performed, the treatment liquid composition is used so as to be adhered in advance to a cloth functioning as a base material of the printed material, and the treatment liquid composition contains, for example, a cationic compound and the water and/or the organic solvent described above.

The cationic compound has a function to aggregate the components of the ink composition. Hence, when the ink composition is adhered to the cloth to which the treatment liquid is adhered, the cationic compound promotes the aggregation of the pigment particles and/or increases the viscosity of the ink composition, thereby suppressing absorption of the ink composition between or in the fibers forming the cloth. As described above, the cationic compound maintains the ink composition on the surface of the cloth, the degree of whiteness of the ink composition in the printed material is improved. In addition, blurring and/or bleeding is also suppressed.

Although the cationic compound is not particularly limited, for example, there may be mentioned a polyvalent metal salt, such as a calcium salt or a magnesium salt, a cationic resin, such as a cationic urethane-based resin, olefin-based resin, or allylamine-based resin, a cationic surfactant, an inorganic acid, or an organic acid. In addition, although the salt of a polyvalent metal is not particularly limited, for example, there may be mentioned a salt of a carboxylic acid, such as formic acid, acetic acid, or benzoic acid, a sulfate salt, a nitrate salt, a hydrochloride salt, or a thiocyanate salt. Among those mentioned above, the polyvalent metal salt is preferable since improving the color development of the pigment and being suitably used for a cotton cloth. Those cationic compounds may be used alone, or at least two types thereof may be used in combination.

Although being not particularly limited, the content of the cationic compound is with respect to the total mass of the treatment liquid, preferably 0.1 to 40.0 percent by mass, more preferably 2.0 to 25.0 percent by mass, and further preferably 5.0 to 10.0 percent by mass. When the content of the cationic compound is set in the range described above, precipitation, separation, and/or the like of the cationic compound in the treatment liquid is suppressed, the aggregation of the pigment and the resin particles in the ink composition is promoted, and the absorption of the ink composition between or in the fibers forming the cloth is suppressed. As a result, a phenomenon in which a color material bleeds to a rear side of a printed surface can be suppressed, and hence, the color development of the printed material is improved.

In addition, the cloth is preferably processed by the treatment liquid. When the cloth is processed by the treatment liquid, the components, such as the pigment, contained in the ink composition and the cationic compound in the treatment liquid may react with each other, and the components, such as the pigment, of the ink composition aggregate in the vicinity of the surface of the cloth. Hence, the pigment is not likely to intrude into the cloth, and the degree of whiteness of the ink composition is further improved.

An adhesion method of the treatment liquid is not particularly limited as long as capable of adhering the treatment liquid to at least a part of the cloth. Although the adhesion method of the treatment liquid is not particularly limited, for example, there may be mentioned dipping coating in which the cloth is dipped in the treatment liquid; roller coating in which the treatment liquid is adhered using a brush, a roller, a spatula, a roll coater, or the like; spray coating in which the treatment liquid is sprayed by a spray device; or ink jet coating in which the treatment liquid is adhered by an ink jet method. Among those described above, since the structure of the device is simple, and the adhesion of the treatment liquid is rapidly performed, for example, the dipping coating, the roller coating, or the spray coating is preferably performed.

In the adhesion step, the adhesion amount of the ink composition per unit area of the cloth is preferably 10 to 60 g/m² and is more preferably 15 to 50 g/m².

### —Heating Step—

The ink jet printing method of this embodiment may further comprise, after the adhesion step, a step of heating the ink composition adhered to the cloth (hereinafter, referred to as “heating step” in some cases).

Although a heating method is not particularly limited, for example, a heat press method, a normal pressure steam method, a high pressure steam method, or a thermal fixing method may be mentioned. Although a heat source of the heating is not particularly limited, for example, an infrared lamp may be mentioned.

In consideration of a temperature at which the cross-linkable groups in the cross-linkable group-containing urethane resin particles are cross-linked (deprotection temperature (dissociation temperature) of an isocyanate group), a heating temperature is set such that at least some of the cross-linkable groups are activated. In particular, the heating temperature is preferably approximately 100° C. to 200° C., more preferably 100° C. to 170° C., and further preferably 100° C. to 150° C. Although a time for the heating is not particularly limited, for example, the time is 30 seconds to 20 minutes.

### —Washing Step—

The ink jet printing method of this embodiment may further comprise, after the heating step, a step of washing a recording medium to which the ink composition is adhered (hereinafter, referred to as “washing step” in some cases). By the washing step, a coloring agent which is not used to dye the fibers can be effectively removed. The washing step may be performed, for example, using water and, if needed, may be performed by a soaping treatment. Although a soaping treatment method is not particularly limited, for example, a method in which a non-fixed pigment is washed out with a hot soap liquid or the like may be mentioned.

### EXAMPLES

Hereinafter, the present disclosure will be described in more detail with reference to Examples and Comparative Examples. However, the present disclosure is not limited to the following Examples.

### EXAMPLES 1 TO 16, COMPARATIVE EXAMPLES 1 TO 7

### (Manufacturing of Ink Compositions 1 to 16 and 51 to 57)

### —Preparation of Ink Composition—

Materials were mixed together to obtain the composition shown in the following Table 1 and then sufficiently stirred, so that ink compositions were obtained. In particular, after the materials were uniformly mixed together, insoluble materials were removed by a membrane filter having a pore diameter of 5 μm, so that the ink compositions were prepared. The ink compositions thus obtained were each evaluated by the following evaluation methods. The evaluation results thereof are shown in Table 2.

TABLE 1

| | | INK COMPOSITION (PERCENT BY MASS) | | | | | | | |
|---|---|---|---|---|---|---|---|---|---|
| | | PIGMENT | | | | | | | |
| | | DISPERSION | | | | | | FIRST ORGANIC | |
| | INK | LIQUID | | RESIN | | WAX | | SOLVENT (δH OF 10 | |
| | COMPOSITION | TYPE OF | | PARTICLES | | PARTICLES | | TO LESS THAN 18) | |
| | No. | PIGMENT | AMOUNT | TYPE | AMOUNT | TYPE | AMOUNT | TYPE | AMOUNT |
| EXAMPLE 1 | 1 | PR254 | 3.5 | R-1 | 6.5 | W-1 | 1.0 | TEGmBE | 1.7 |
| EXAMPLE 2 | 2 | PR254 | 3.5 | R-1 | 6.5 | W-1 | 1.0 | TEGmBE | 1.7 |
| EXAMPLE 3 | 3 | PR254 | 3.5 | R-1 | 6.5 | W-1 | 1.0 | TEGmBE | 1.7 |
| EXAMPLE 4 | 4 | PR254 | 3.5 | R-2 | 6.5 | W-1 | 1.0 | TEGmBE | 1.7 |
| EXAMPLE 5 | 5 | PR254 | 3.5 | R-3 | 6.5 | W-1 | 1.0 | 1,2-HD | 1.7 |
| EXAMPLE 6 | 6 | PR255 | 3.5 | R-1 | 6.5 | W-1 | 1.0 | TEGmBE | 1.7 |
| EXAMPLE 7 | 7 | PR264 | 3.5 | R-1 | 6.5 | W-1 | 1.0 | TEGmBE | 1.7 |
| EXAMPLE 8 | 8 | PR270 | 3.5 | R-1 | 6.5 | W-1 | 1.0 | TEGmBE | 1.7 |
| EXAMPLE 9 | 9 | PR272 | 3.5 | R-1 | 6.5 | W-1 | 1.0 | TEGmBE | 1.7 |
| EXAMPLE 10 | 10 | PR254 | 3.5 | R-1 | 6.5 | W-1 | 1.0 | TEGmBE | 1.7 |
| EXAMPLE 11 | 11 | PR254 | 3.5 | R-1 | 6.5 | W-1 | 1.0 | TEGmBE | 0.5 |
| EXAMPLE 12 | 12 | PR254 | 3.5 | R-1 | 6.5 | W-1 | 1.0 | TEGmBE | 4.0 |
| EXAMPLE 13 | 13 | PR254 | 3.5 | R-1 | 6.5 | W-1 | 1.0 | TEGmBE | 0.4 |
| EXAMPLE 14 | 14 | PR254 | 3.5 | R-1 | 6.5 | W-1 | 1.0 | TEGmBE | 1.7 |
| EXAMPLE 15 | 15 | PR254 | 3.5 | R-1 | 6.5 | W-1 | 1.0 | TEGmBE | 1.7 |
| EXAMPLE 16 | 16 | PR254 | 3.5 | R-1 | 6.5 | — | — | TEGmBE | 1.7 |
| COMPARATIVE | 51 | PR177 | 3.5 | R-1 | 6.5 | W-1 | 1.0 | TEGmBE | 1.7 |
| EXAMPLE 1 | | | | | | | | | |
| COMPARATIVE | 52 | PR254 | 3.5 | R-51 | 6.5 | W-1 | 1.0 | TEGmBE | 1.7 |
| EXAMPLE 2 | | | | | | | | | |
| COMPARATIVE | 53 | PR254 | 3.5 | R-52 | 6.5 | W-1 | 1.0 | TEGmBE | 1.7 |
| EXAMPLE 3 | | | | | | | | | |
| COMPARATIVE | 54 | PR254 | 3.5 | R-53 | 6.5 | W-1 | 1.0 | TEGmBE | 1.7 |
| EXAMPLE 4 | | | | | | | | | |
| COMPARATIVE | 55 | PR254 | 4.5 | R-1 | 6.5 | W-1 | 2.0 | — | — |
| EXAMPLE 5 | | | | | | | | | |
| COMPARATIVE | 56 | PR254 | 4.5 | R-1 | 6.5 | W-1 | 2.0 | — | — |
| EXAMPLE 6 | | | | | | | | | |
| COMPARATIVE | 57 | PR254 | 4.5 | R-1 | 6.5 | W-1 | 2.0 | — | — |
| EXAMPLE 7 | | | | | | | | | |

| | INK COMPOSITION (PERCENT BY MASS) | | | | | | |
|---|---|---|---|---|---|---|---|
| | SECOND ORGANIC | | THIRD ORGANIC | | | | |
| | SOLVENT (δH OF | | SOLVENT (δH OF | | | | PURE |
| | LESS THAN 10) | | 18 OR MORE) | | SURFACTANT | | WATER |
| | TYPE | AMOUNT | TYPE | AMOUNT | TYPE | AMOUNT | AMOUNT |
| EXAMPLE 1 | 2-P | 1.0 | Gly/TEA/TMP | 4.5/1.0/4.5 | E1010 | 0.5 | BALANCE |
| EXAMPLE 2 | 2-P | 0.1 | Gly/TEA/TMP | 4.5/1.0/4.5 | E1010 | 0.5 | BALANCE |
| EXAMPLE 3 | 2-P | 4.0 | Gly/TEA/TMP | 4.5/1.0/4.5 | E1010 | 0.5 | BALANCE |
| EXAMPLE 4 | 2-P | 1.0 | Gly/TEA/TMP | 4.5/1.0/4.5 | E1010 | 0.5 | BALANCE |
| EXAMPLE 5 | 2-P | 1.0 | Gly/TEA/TMP | 4.5/1.0/4.5 | E1010 | 0.5 | BALANCE |
| EXAMPLE 6 | 2-P | 1.0 | Gly/TEA/TMP | 4.5/1.0/4.5 | E1010 | 0.5 | BALANCE |
| EXAMPLE 7 | 2-P | 1.0 | Gly/TEA/TMP | 4.5/1.0/4.5 | E1010 | 0.5 | BALANCE |
| EXAMPLE 8 | 2-P | 1.0 | Gly/TEA/TMP | 4.5/1.0/4.5 | E1010 | 0.5 | BALANCE |
| EXAMPLE 9 | 2-P | 1.0 | Gly/TEA/TMP | 4.5/1.0/4.5 | E1010 | 0.5 | BALANCE |
| EXAMPLE 10 | — | 0 | Gly/TEA/TMP | 4.5/1.0/4.5 | E1010 | 0.5 | BALANCE |
| EXAMPLE 11 | — | 0 | Gly/TEA/TMP | 4.5/1.0/4.5 | E1010 | 0.5 | BALANCE |
| EXAMPLE 12 | — | 0 | Gly/TEA/TMP | 4.5/1.0/4.5 | E1010 | 0.5 | BALANCE |
| EXAMPLE 13 | 2-P | 0.2 | Gly/TEA/TMP | 10/1.0/4.5 | E1010 | 0.5 | BALANCE |
| EXAMPLE 14 | 2-P | 1.0 | Gly/TEA/TMP | 10/1.0/4.5 | E1010 | 0.5 | BALANCE |
| EXAMPLE 15 | 2-P | 1.0 | Gly/TEA/TMP | 2.0/1.0/4.5 | E1010 | 0.5 | BALANCE |
| EXAMPLE 16 | 2-P | 1.0 | Gly/TEA/TMP | 4.5/1.0/4.5 | E1010 | 0.5 | BALANCE |
| COMPARATIVE | 2-P | 1.0 | Gly/TEA/TMP | 4.5/1.0/4.5 | E1010 | 0.5 | BALANCE |
| EXAMPLE 1 | | | | | | | |
| COMPARATIVE | 2-P | 1.0 | Gly/TEA/TMP | 4.5/1.0/4.5 | E1010 | 0.5 | BALANCE |
| EXAMPLE 2 | | | | | | | |
| COMPARATIVE | 2-P | 1.0 | Gly/TEA/TMP | 4.5/1.0/4.5 | E1010 | 0.5 | BALANCE |
| EXAMPLE 3 | | | | | | | |
| COMPARATIVE | 2-P | 1.0 | Gly/TEA/TMP | 4.5/1.0/4.5 | E1010 | 0.5 | BALANCE |
| EXAMPLE 4 | | | | | | | |
| COMPARATIVE | — | — | Gly/TEA/TMP | 4.5/1.0/4.5 | E1010 | 0.6 | BALANCE |
| EXAMPLE 5 | | | | | | | |
| COMPARATIVE | 2-P | 10.0 | — | — | E1010 | 0.6 | BALANCE |
| EXAMPLE 6 | | | | | | | |
| COMPARATIVE | 2-P | 1.0 | Gly/TEA/TMP | 4.5/1.0/4.5 | E1010 | 0.6 | BALANCE |
| EXAMPLE 7 | | | | | | | |

The materials shown in Table 1 are as follows. In addition, the numerical unit of the content described in the table is percent by mass. The contents of the resin particles and the wax particles are each a solid component basis.

### —Pigment—

PR254: C.I. Pigment Red 254 (3,6-bis(4-chlorophenyl)-2,5-dihydropyrrolo[3,4-c]pyrrole-1,4-dione)
PR255: C.I. Pigment Red 255 (3,6-diphenyl-2,5-dihydropyrrolo[3,4-c]pyrrole-1,4-dione)
PR264: C.I. Pigment Red 264 (3,6-di(biphenyl-4-yl)pyrrolo[3,4-c]pyrrole-1,4(2H,5H)-dione)
PR270: C.I. Pigment Red 270 (diketopyrrolopyrrole-based pigment)
PR272: C.I. Pigment Red 272 (3,6-bis(4-methylphenyl-2,5-dihydropyrrolo[3,4-c]pyrrole-1,4-dione)
PR177: C.I. Pigment Red 177 (4,4′-diamino-1,1′-bianthracene-9,9′,10,10′-tetraone)

### —Resin Particle Emulsion—

R-1: urethane resin particle emulsion “ETERNACOLL UW-1501F” (product name, manufactured by Ube Industries, Ltd., cross-linkable group: blocked isocyanate, glass transition temperature: −30° C., Young's modulus: 50 MPa)
R-2: urethane resin particle emulsion “Takelac WS-5984” (product name, manufactured by Mitsui Chemicals Inc., cross-linkable group: silanol, glass transition temperature: 70° C., Young's modulus: 10 MPa)
R-3: urethane resin particle emulsion “Takelac WS-5000” (product name, manufactured by Mitsui Chemicals Inc., cross-linkable group: silanol, glass transition temperature: 65° C., Young's modulus: 10 MPa)
R-51: urethane resin particle emulsion “Permarin UA-368T” (product name, manufactured by Sanyo Chemical Industries, Ltd., cross-linkable group: no, glass transition temperature: −20° C., Young's modulus: 5 MPa)
R-52: urethane resin particle emulsion “Takelac W-6110” (product name, manufactured by Mitsui Chemicals Inc., cross-linkable group: no, glass transition temperature: −20° C., Young's modulus: 6 MPa)
R-53: urethane resin particle emulsion “U-Coat UX-8100” (product name, manufactured by Sanyo Chemical Industries, Ltd., cross-linkable group: no, glass transition temperature: −80° C., Young's modulus: 50 MPa)

### —Wax—

W-1: wax emulsion “E-6500” (product name, manufactured by Toho Chemical Industry Co., Ltd.)

### —Organic Solvent—

TEGmBE: triethylene glycol monobutyl ether (δh=10.9)
1,2-HD: 1,2-hexanediol (δh=17.1)
2-P: 2-pyrrolidone (δh=9.0)
Gly: glycerin (δh=23.0)
TEA: triethanolamine (δh=21.0)
TMP: trimethylolpropane (δh=21.1)

### —Surfactant—

E1010: acetylene glycol-based surfactant “Olfine E1010” (product name, manufactured by Air Products)

### Evaluation of Ink Composition

### —Storage Stability—

After the ink composition thus prepared was charged in a 50-cc glass bottle container, this glass bottle was sealed and then placed in a constant-temperature bath at 60° C. After being left for 7 days, the glass bottle was recovered and cooled to room temperature (25° C.), and the viscosity of the ink composition was measured. A rate of increase in viscosity of the ink composition after the seven-day storage to the viscosity thereof immediately after the preparation was calculated, and the storage stability was evaluated in accordance with the following evaluation criteria. In addition, the viscosity [mPa·s] was measured at a revolution rate of 100 rpm and a temperature of 20° C. using a corn (diameter: 75 mm, angle:)1° by a viscometer “MCR-300” (product name, manufactured by Physica). The evaluation criteria are shown below.
A: rate of increase in viscosity is less than 3.0%.
B: rate of increase in viscosity is 3.0% to less than 5.0%.
C: rate of increase in viscosity is 5.0% to less than 10%.
D: rate of increase in viscosity is 10% or more.

### —Ejection Stability—

After the ink composition thus prepared was charged in an ink cartridge of an ink jet printer “PX-G930” (product name, manufactured by Seiko Epson Corporation), by using an ink jet ejection observation device “Dot View” (product name, manufactured by Tritek Co., Ltd.), an ejection rate of the ink was adjusted to the value shown below. Subsequently, nozzle missing and flight deflection were observed, and the ejection stability was evaluated in accordance with the following evaluation criteria. The evaluation criteria are shown below. When the evaluation of the ejection stability is C or more, it can be said that a preferable result is obtained.
A: No nozzles causing nozzle missing and flight deflection at an ejection rate of 6 m/s are confirmed, and no nozzles causing nozzle missing and flight deflection at an ejection rate of 7 m/s are confirmed.
B: No nozzles causing nozzle missing and flight deflection at an ejection rate of 6 m/s are confirmed, and the number of nozzles causing nozzle missing or flight deflection at an ejection rate of 7 m/s is confirmed to be more than 0% to 3% with respect to the total number of nozzles.
C: No nozzles causing nozzle missing and flight deflection at an ejection rate of 6 m/s are confirmed, and the number of nozzles causing nozzle missing or flight deflection at an ejection rate of 7 m/s is confirmed to be more than 3% with respect to the total number of nozzles.
D: The number of nozzles causing nozzle missing or flight deflection at an ejection rate of 6 m/s is confirmed to be more than 0% to 3% with respect to the total number of nozzles.

### Evaluation of Ink Jet Printing Method by Ink Composition

### —Preparation of Treatment Liquid and Treatment of Cloth—

After ion-exchanged water was added to 20.0 parts by mass of calcium nitrate tetrahydrate (Ca: 17 percent by mass), 2.0 parts by mass of a fixing resin “Mowinyl 6960” (product name, manufactured by Nippon Synthetic Chemical Industries Co., Ltd.), and 0.5 parts by mass of an acetylene glycol-based surfactant “Olfine E1010” (product name, manufactured by Nisshin Chemical Industry Co., Ltd.) so that the total mass was 100 parts by mass, mixing and stirring were performed to obtain a treatment liquid.

As the cloth, the following T shirt cloth (manufactured by Hanes, cloth color: white, material: 100% of cotton) was prepared, and the treatment liquid obtained as described above was uniformly applied thereto using a roller device so that the amount of the liquid per A4 size of 210×297 mm was 18 to 20 g. After the treatment liquid was applied, a heat treatment was performed at 160° C. for one minute using a heat press machine.

### Ink Jet Printing Method

By an ink jet method using an ink jet printer (product name “PX-G930”, manufactured by Seiko Epson Corporation), the ink composition prepared as described above was adhered to the cloth thus treated to print an image thereon. A printed pattern (image) was set to have a resolution of 1,440×720 dpi in a printing range of 210 mm×297 mm, and a solid image was printed.

Subsequently, as a pre-drying, after a heat treatment was performed at 60° C. for 5 minutes on the cloth to which the ink composition was adhered, a heat treatment at 160° C. for 5 minutes was performed by using a conveyor drying furnace “Economax D” (manufactured by M&R), followed by cooling the temperature to 25° C., so that a printed material was obtained.

### —Color Development—

Evaluation of color development was performed on the printed material thus obtained by measuring an optical density (hereinafter, referred to as “OD value” in some cases) of the image using a colorimeter “Spectrolino” (product name, manufactured by X-RITE), and based on the OD value thus measured, the color development of the image was evaluated. The evaluation criteria are shown below. When the evaluation of the color development is B or more, it can be said that a preferable result is obtained.
A: OD value of 1.5 or more
B: OD value of 1.25 to less than 1.5
C: OD value of less than 1.25

### —Friction Fastness—

A friction fastness test of the printed material was performed using a Gakushin type friction fastness tester “AB-301” (product name, manufactured by Tester Sangyo Co., Ltd.) which was configured in accordance with a JIS L0849: 2013 friction tester II type. In the friction fastness test, a load of 200g was used, the number of reciprocating operations was set to 100 times, and as a cloth to be tested, a white cloth for JIS color fastness test (in compliance with No. 3-1 of JIS L 0803: 2011, unbleached muslin No.3) was used. The level determination was performed using a dyeing gray scale by visual inspection, so that the friction fastness of the printed material was evaluated. The evaluation criteria are shown below. A dry friction fastness or a wet friction fastness, whichever was lower, was employed and evaluated in accordance with the following criteria. When the evaluation of the friction fastness is B or more, it can be said that a preferable result is obtained.
A: Level 3 or more
B: Level 2 to 3
C: Level 2 or less

TABLE 2

| | | INK COMPOSITION (PERCENT BY MASS) | | | | | | | |
|---|---|---|---|---|---|---|---|---|---|
| | | | | | | FIRST ORGANIC | | SECOND ORGANIC | |
| | INK | | URETHANE RESIN PARTICLES | | | SOLVENT(δH OF 10 | | SOLVENT (δH OF | |
| | COMPOSITION | PIGMENT | | CROSS-LINKABLE | WAX | TO LESS THAN 18) | | LESS THAN 10) | |
| | No. | MATERIAL | TYPE | GROUP | PARTICLES | TYPE | AMOUNT | TYPE | AMOUNT |
| EXAMPLE 1 | 1 | PR254 | R-1 | BLOCKED | YES | TEGmBE | 1.7 | 2-P | 1.0 |
| | | | | ISOCYANATE | | | | | |
| EXAMPLE 2 | 2 | PR254 | R-1 | BLOCKED | YES | TEGmBE | 1.7 | 2-P | 0.1 |
| | | | | ISOCYANATE | | | | | |
| EXAMPLE 3 | 3 | PR254 | R-1 | BLOCKED | YES | TEGmBE | 1.7 | 2-P | 4.0 |
| | | | | ISOCYANATE | | | | | |
| EXAMPLE 4 | 4 | PR254 | R-2 | SILANOL | YES | TEGmBE | 1.7 | 2-P | 1.0 |
| EXAMPLE 5 | 5 | PR254 | R-3 | SILANOL | YES | 1,2-HD | 1.7 | 2-P | 1.0 |
| EXAMPLE 6 | 6 | PR255 | R-1 | BLOCKED | YES | TEGmBE | 1.7 | 2-P | 1.0 |
| | | | | ISOCYANATE | | | | | |
| EXAMPLE 7 | 7 | PR264 | R-1 | BLOCKED | YES | TEGmBE | 1.7 | 2-P | 1.0 |
| | | | | ISOCYANATE | | | | | |
| EXAMPLE 8 | 8 | PR270 | R-1 | BLOCKED | YES | TEGmBE | 1.7 | 2-P | 1.0 |
| | | | | ISOCYANATE | | | | | |
| EXAMPLE 9 | 9 | PR272 | R-1 | BLOCKED | YES | TEGmBE | 1.7 | 2-P | 1.0 |
| | | | | ISOCYANATE | | | | | |
| EXAMPLE 10 | 10 | PR254 | R-1 | BLOCKED | YES | TEGmBE | 1.7 | — | 0 |
| | | | | ISOCYANATE | | | | | |
| EXAMPLE 11 | 11 | PR254 | R-1 | BLOCKED | YES | TEGmBE | 0.5 | — | 0 |
| | | | | ISOCYANATE | | | | | |
| EXAMPLE 12 | 12 | PR254 | R-1 | BLOCKED | YES | TEGmBE | 4.0 | — | 0 |
| | | | | ISOCYANATE | | | | | |
| EXAMPLE 13 | 13 | PR254 | R-1 | BLOCKED | YES | TEGmBE | 0.4 | 2-P | 0.2 |
| | | | | ISOCYANATE | | | | | |
| EXAMPLE 14 | 14 | PR254 | R-1 | BLOCKED | YES | TEGmBE | 1.7 | 2-P | 1.0 |
| | | | | ISOCYANATE | | | | | |
| EXAMPLE 15 | 15 | PR254 | R-1 | BLOCKED | YES | TEGmBE | 1.7 | 2-P | 1.0 |
| | | | | ISOCYANATE | | | | | |
| EXAMPLE 16 | 16 | PR254 | R-1 | BLOCKED | NO | TEGmBE | 1.7 | 2-P | 1.0 |
| | | | | ISOCYANATE | | | | | |
| COMPARATIVE | 51 | PR177 | R-1 | BLOCKED | YES | TEGmBE | 1.7 | 2-P | 1.0 |
| EXAMPLE 1 | | | | ISOCYANATE | | | | | |
| COMPARATIVE | 52 | PR254 | R-51 | NO | YES | TEGmBE | 1.7 | 2-P | 1.0 |
| EXAMPLE 2 | | | | | | | | | |
| COMPARATIVE | 53 | PR254 | R-52 | NO | YES | TEGmBE | 1.7 | 2-P | 1.0 |
| EXAMPLE 3 | | | | | | | | | |
| COMPARATIVE | 54 | PR254 | R-53 | NO | YES | TEGmBE | 1.7 | 2-P | 1.0 |
| EXAMPLE 4 | | | | | | | | | |
| COMPARATIVE | 55 | PR254 | R-1 | BLOCKED | YES | — | — | — | — |
| EXAMPLE 5 | | | | ISOCYANATE | | | | | |
| COMPARATIVE | 56 | PR254 | R-1 | BLOCKED | YES | — | — | 2-P | 10.0 |
| EXAMPLE 6 | | | | ISOCYANATE | | | | | |
| COMPARATIVE | 57 | PR254 | R-1 | BLOCKED | YES | — | — | 2-P | 1.0 |
| EXAMPLE 7 | | | | ISOCYANATE | | | | | |

| | INK COMPOSITION (PERCENT BY MASS) | | | | | | | |
|---|---|---|---|---|---|---|---|---|
| | SECOND ORGANIC | | THIRD ORGANIC | | | | | |
| | SOLVENT (δH OF | | SOLVENT (δH OF | | EVALUATION | | | |
| | LESS THAN 10) | | 18 OR MORE) | | STORAGE | EJECTION | COLOR | FRICTION |
| | TYPE | AMOUNT | TYPE | AMOUNT | STABILITY | STABILITY | DEVELOPMENT | FASTNESS |
| EXAMPLE 1 | 2-P | 1.0 | Gly/TEA/TMP | 4.5/1/4.5 | A | A | A | A |
| EXAMPLE 2 | 2-P | 0.1 | Gly/TEA/TMP | 4.5/1/4.5 | B | B | A | A |
| EXAMPLE 3 | 2-P | 4.0 | Gly/TEA/TMP | 4.5/1/4.5 | B | A | B | A |
| EXAMPLE 4 | 2-P | 1.0 | Gly/TEA/TMP | 4.5/1/4.5 | A | A | A | A |
| EXAMPLE 5 | 2-P | 1.0 | Gly/TEA/TMP | 4.5/1/4.5 | A | A | A | A |
| EXAMPLE 6 | 2-P | 1.0 | Gly/TEA/TMP | 4.5/1/4.5 | A | A | A | A |
| EXAMPLE 7 | 2-P | 1.0 | Gly/TEA/TMP | 4.5/1/4.5 | A | A | A | A |
| EXAMPLE 8 | 2-P | 1.0 | Gly/TEA/TMP | 4.5/1/4.5 | A | A | A | A |
| EXAMPLE 9 | 2-P | 1.0 | Gly/TEA/TMP | 4.5/1/4.5 | A | A | A | A |
| EXAMPLE 10 | — | 0 | Gly/TEA/TMP | 4.5/1/4.5 | B | B | A | A |
| EXAMPLE 11 | — | 0 | Gly/TEA/TMP | 4.5/1/4.5 | C | B | A | A |
| EXAMPLE 12 | — | 0 | Gly/TEA/TMP | 4.5/1/4.5 | A | A | B | A |
| EXAMPLE 13 | 2-P | 0.2 | Gly/TEA/TMP | 10/1/4.5 | B | C | A | A |
| EXAMPLE 14 | 2-P | 1.0 | Gly/TEA/TMP | 0/1/4.5 | A | C | B | A |
| EXAMPLE 15 | 2-P | 1.0 | Gly/TEA/TMP | 2/1/4.5 | B | C | A | A |
| EXAMPLE 16 | 2-P | 1.0 | Gly/TEA/TMP | 4.5/1/4.5 | B | A | A | B |
| COMPARATIVE | 2-P | 1.0 | Gly/TEA/TMP | 4.5/1/4.5 | A | A | C | A |
| EXAMPLE 1 | | | | | | | | |
| COMPARATIVE | 2-P | 1.0 | Gly/TEA/TMP | 4.5/1/4.5 | D | D | A | C |
| EXAMPLE 2 | | | | | | | | |
| COMPARATIVE | 2-P | 1.0 | Gly/TEA/TMP | 4.5/1/4.5 | D | D | A | C |
| EXAMPLE 3 | | | | | | | | |
| COMPARATIVE | 2-P | 1.0 | Gly/TEA/TMP | 4.5/1/4.5 | A | A | A | C |
| EXAMPLE 4 | | | | | | | | |
| COMPARATIVE | — | — | Gly/TEA/TMP | 4.5/1/4.5 | D | D | B | A |
| EXAMPLE 5 | | | | | | | | |
| COMPARATIVE | 2-P | 10.0 | — | — | D | D | C | A |
| EXAMPLE 6 | | | | | | | | |
| COMPARATIVE | 2-P | 1.0 | Gly/TEA/TMP | 4.5/1/4.5 | B | D | A | A |
| EXAMPLE 7 | | | | | | | | |

The numerical unit of the content described in Table is percent by mass. From the results of Examples and Comparative Examples, it is found that according to the ink composition and the ink jet printing method of this embodiment, while an excellent color development is obtained, the ejection stability and the friction fastness of the printed material are also excellent. In addition, the ink composition is also excellent in storage stability.

By comparison between the results of Example 1 and Comparative Example 1, it is found that the ink composition and the ink jet printing method of this embodiment each show an excellent color development since using the diketopyrrolopyrrole-based pigment.

By comparison between the results of Example 1 and Comparative Examples 2 to 4, it is found that since the ink composition and the ink jet printing method of this embodiment each use the cross-linkable group-containing urethane resin particles, the storage stability, the ejection stability, the color development, and the friction fastness are each excellent.

By comparison between the results of Example 1 and Comparative Examples 5 and 6, it is found that since the ink composition and the ink jet printing method of this embodiment each use the first organic solvent, the storage stability, the ejection stability, the color development, and the friction fastness are each excellent.

From the results of Examples 1 to 3, it is found that since the content of the second organic solvent is 0.1 to 4.0 percent by mass, and the ink composition and the ink jet printing method of this embodiment each use the cross-linkable group-containing urethane resin particles, the storage stability, the ejection stability, and the friction fastness are each excellent.

From the results of Examples 1, 4, and 5, it is found that even if a silanol is used as the cross-linkable group of the urethane resin particles, the ink composition and the ink jet printing method of this embodiment each simultaneously achieve excellent storage stability, ejection stability, color development, and friction fastness. In addition, in Examples 4 and 5, when the cloths after pre-dried were overlapped with each other, color transfer occurred in some cases from a printed portion to a cloth in contact therewith.

By the comparison between the results of Examples 1 and 6 to 9, it is found that even when any one of the diketopyrrolopyrrole-based pigments is used, the ink composition and the ink jet printing method of this embodiment each simultaneously achieve excellent storage stability, ejection stability, color development, and friction fastness.

From the results of Examples 1 and 10, it is found that since the second organic solvent is contained, the ink composition and the ink jet printing method of this embodiment each achieve excellent storage stability and ejection stability.

From the results of Examples 10 to 12, it is found that even when the ink composition and the ink jet printing method of this embodiment each use no second organic solvent, the storage stability, the ejection stability, the color development, and the friction fastness are each excellent.

From the results of Example 13, it is found that in the ink composition and the ink jet printing method of this embodiment, when the content of the first organic solvent is 0.4 percent by mass or more, and the content of the second organic solvent is 0.2 percent by mass or more, the storage stability, the ejection stability, the color development, and the friction fastness are each excellent.

From the results of Examples 14 and 15, it is found that in the ink composition and the ink jet printing method of this embodiment, when the content of the third organic solvent is 7.5 to 15.5 percent by mass, the storage stability, the ejection stability, the color development, and the friction fastness are each excellent.

From the results of Example 16, it is found that in the ink composition and the ink jet printing method of this embodiment, even when no waxes are contained, the storage stability, the ejection stability, the color development, and the friction fastness are each excellent.

What is claimed is:

1. An ink jet printing ink composition comprising:
cross-linkable group-containing urethane resin particles;
a diketopyrrolopyrrole-based pigment; and
a first organic solvent having a hydrogen bond term δh of 10 to less than 18 in Hansen solubility parameters.

2. The ink jet printing ink composition according to claim 1,
wherein the cross-linkable group-containing urethane resin particles have a glass transition temperature of 5° C. or less.

3. The ink jet printing ink composition according to claim 1,
wherein the first organic solvent includes an alcohol-based solvent or an ether-based solvent.

4. The ink jet printing ink composition according to claim 1,
further comprising a second organic solvent having a hydrogen bond term δh of less than 10.

5. The ink jet printing ink composition according to claim 4,
wherein the second organic solvent includes a lactam-based solvent.

6. The ink jet printing ink composition according to claim 1,
further comprising a lubricant.

7. An ink jet printing method comprising:
an ink adhesion step of ejecting an ink jet printing ink composition by an ink jet method to be adhered to a recording medium,
wherein the ink jet printing ink composition includes:
cross-linkable group-containing urethane resin particles;
a diketopyrrolopyrrole-based pigment; and
a first organic solvent having a hydrogen bond term δh of 10 to less than 18 in Hansen solubility parameters.
